(19) United States
(12) Patent Application Publication
(10) Pub. No.: US 2026/0253640 A1
(43) Pub. Date: Aug. 27, 2026

(54) WIRING METHOD AND SYSTEM, DEVICE, STORAGE MEDIUM, AND CHIP

(71) Applicant: Celestica Technology Consultancy (Shanghai) Co. Ltd, Shanghai (CN)

(72) Inventors: Jinbin Qin, Shanghai (CN); Jun You, Shanghai (CN); Feng Chen, Shanghai (CN)

(21) Appl. No.: 19/331,940

(22) Filed: Sep. 17, 2025

(30) Foreign Application Priority Data
Feb. 21, 2025 (CN) 2025102007535

(51) Int. Cl. G11C 16/08; G11C 5/06; G11C 5/12; G11C 16/30; H05K 1/02

(52) U.S. Cl. CPC G11C 16/08; G11C 5/063; G11C 5/12; G11C 16/30; H05K 1/029

(57) ABSTRACT

The present disclosure provides a wiring method and system, a device, a storage medium, and a chip. The wiring method comprises: cross-connecting a storage medium to at least two control nodes so that dual ports of the storage medium are respectively connected to different processor ports of different control nodes; merging long distance lines between the at least two control nodes and the storage medium using re-timers; and dynamically configuring a physical address corresponding to each line of the control node so that a physical address of the storage medium remains consistent when connected to different control nodes. The wiring method can solve the problem of the count of re-timers under the premise of consistent physical addresses, thereby optimizing the wiring layout, reducing redundant architecture, and improving the operation efficiency of the entire machine.

### FIELD OF THE INVENTION

The present disclosure belongs to the field of printed-circuit-board (PCB) routing topology technology, relates to a wiring method, and in particular to a wiring method and system, a device, a storage medium, and a chip.

### BACKGROUND OF THE INVENTION

In modern data storage and computing systems, redundant architecture design is a critical means to ensure high availability and fault tolerance. By deploying multiple independent control nodes or processing units, the system can maintain continuous operation in the event of a single component failure, meeting the stringent stability and reliability requirements of enterprise-level applications. However, while traditional redundant architectures achieve fault tolerance, they often introduce inherent systemic drawbacks that severely constrain overall performance and resource efficiency. First, existing redundancy solutions commonly suffer from low resource utilization. To ensure seamless switching between nodes, hardware designs typically employ symmetric layouts and uniform configurations, preventing redundant components from being allocated flexibly based on actual demands. Second, redundant architectures significantly increase system complexity and maintenance difficulty. Physical interconnections between multiple nodes often rely on intricate trace topologies to ensure signal synchronization and data consistency. Finally, traditional redundancy solutions exhibit notable shortcomings in scalability and adaptability. As data volumes grow exponentially and storage medium densities increase, systems must support more device connections and higher-speed data exchange, yet the rigid design of conventional architectures struggles to accommodate dynamically changing load requirements.

Therefore, existing redundant architectures sacrifice efficiency, cost-effectiveness, and scalability in the pursuit of reliability, urgently necessitating a novel design paradigm to provide technical support for next-generation high-performance storage and computing systems.

### SUMMARY OF THE INVENTION

In view of the above shortcomings of the prior art, the purpose of the present disclosure is to provide a wiring method and system, a device, a storage medium, and a chip to solve the problems of complex redundant architecture design and low scalability in the prior art.

In a first aspect, the present disclosure provides a wiring method, comprising cross-connecting a storage medium to at least two control nodes so that dual ports of the storage medium are respectively connected to different processor ports of different control nodes; merging long distance lines between the at least two control nodes and the storage medium using re-timers; and dynamically configuring a physical address corresponding to each line of the control node so that a physical address of the storage medium remains consistent when connected to different control nodes.

According to the present disclosure, the storage medium is cross-connected to the at least two control nodes so that the dual ports of the storage medium are respectively connected to different processor ports of different control nodes; each of the long distance lines is merged using one re-timer; and the physical address corresponding to each line of the control node is dynamically configured so that the physical address of the storage medium remains consistent when connected to different control nodes. The wiring method can solve the problem of the count of re-timers under the premise of consistent physical addresses, thereby optimizing the wiring layout, reducing redundant architecture, and improving the operation efficiency of the entire machine.

In one embodiment of the first aspect, the at least two control nodes comprise a first control node and a second control node, control node processors comprise a first control node processor and a second control node processor, and the processor ports for each of the control node processors comprise a first port and a second port. The storage medium is cross-connected to the control nodes so that the dual ports of the storage medium are respectively connected to different processor ports of different control nodes. A head port of the storage medium is connected to the first port of the first control node processor, and a tail port of the storage medium is connected to the first port of the second control node processor; the head port of the storage medium is connected to the second port of the second control node processor, and the tail port of the storage medium is connected to the second port of the first control node processor.

In one embodiment of the first aspect, the dynamically configuring a physical address corresponding to each line of the control node so that a physical address of the storage medium remains consistent when connected to different control nodes comprises: identifying a physical location of each of the control nodes using a level signal by a hardware detection module; dynamically configuring the physical address corresponding to each line according to the physical location of the control node so that the physical address of the storage medium remains consistent when connected to different control nodes.

In one embodiment of the first aspect, the identifying a physical location of each of the control nodes using a level signal by a hardware detection module comprises: generating a high-level signal by connecting one of the control nodes to a power supply using a first resistor, and generating a low-level signal by connecting the other one of the control nodes to the ground using a second resistor; assigning the high-level signal and the low-level signal to different control nodes, respectively, to identify the physical locations of the control nodes.

In one embodiment of the first aspect, the at least two control nodes comprise a first control node and a second control node, control node processors comprise a first control node processor and a second control node processor, and the processor ports for each of the control node processors comprise a first port and a second port; the identifying a physical location of each of the control nodes using a level signal by a hardware detection module comprises: when the hardware detection module identifies the first control node using the level signal, the first port of the first control node processor is configured to be connected to a head port of the storage medium, and the second port of the first control node processor is configured to be connected to a tail port of the storage medium; when the hardware detection module identifies the second control node using the level signal, the first port of the second control node processor is configured to be connected to the tail port of the storage medium, and the second port of the second control node processor is configured to be connected to the head port of the storage medium.

In one embodiment of the first aspect, each of the long distance lines exceeds a preset threshold and is configured with one re-timer.

In a second aspect, the present disclosure provides a wiring system, comprising a line layout module configured to cross-connect a storage medium to at least two control nodes so that dual ports of the storage medium are respectively connected to different processor ports of different control nodes; a line merging module configured to merge long distance lines between the at least two control nodes and the storage medium using re-timers; and an address mapping module configured to dynamically configure a physical address corresponding to each line of the control node so that a physical address of the storage medium remains consistent when connected to different control nodes.

In a third aspect, the present disclosure provides a chip, comprising a backplane configured to provide physical connection interfaces; at least two control nodes configured to execute the wiring method of any embodiment of the first aspect; and a plurality of dual-port storage media configured to be cross-connected to the control nodes through the backplane, two ports of each storage medium being connected to different control nodes, respectively.

In a fourth aspect, the present disclosure provides an electronic device, comprising a memory configured to store programmable logic programs; a programmable logic device configured to load the programmable logic programs stored in the memory so that the electronic device executes the wiring method of any embodiment of the first aspect.

In a fifth aspect, the present disclosure provides a non-volatile readable storage medium, comprising programmable logic programs, wherein when the programmable logic programs are executed by a programmable logic device, the wiring method of any embodiment of the first aspect is implemented.

### BRIEF DESCRIPTION OF DRAWINGS

FIG. 1 is a schematic diagram showing an application scenario of a wiring method according to the embodiments of the present disclosure.

FIG. 2 is a schematic flowchart showing a wiring method according to the embodiments of the present disclosure.

FIG. 3 is a schematic diagram showing a wiring method according to the embodiments of the present disclosure.

FIG. 4 is a schematic flowchart showing a wiring method according to the embodiments of the present disclosure.

FIG. 5 is a schematic diagram showing a wiring method according to the embodiments of the present disclosure.

FIG. 6 is a schematic structural diagram showing a wiring system according to the embodiments of the present disclosure.

FIG. 7 is a schematic structural diagram showing a chip according to the embodiments of the present disclosure.

FIG. 8 is a schematic structural diagram showing an electronic device according to the embodiments of the present disclosure.

### REFERENCE NUMERALS

1 Printed circuit board
11 Node
12 Circuit backplane
13 NVMe drive
100 Wiring system
110 Line layout module
120 Line merging module
130 Address mapping module
200 Chip
210 Backplane
220 Control node
230 Dual-port storage medium
800 Electronic device
810 Memory
820 Programmable logic device
S11-S13 Steps 11 to 13
S131-S132 Steps 131 to 132

### DETAILED DESCRIPTION OF THE INVENTION

The following describes the embodiments of the present disclosure through specific examples. Those skilled in the art can easily understand the other advantages and effects of the present disclosure from the content disclosed in this specification. The present disclosure can also be implemented or applied through other different specific embodiments. The details in this specification can also be modified or changed based on different viewpoints and applications without departing from the spirit of the present disclosure. It should be noted that the following embodiments and features in the embodiments can be combined with each other in the absence of any conflict.

It should be noted that in the embodiments of the present disclosure, the words “optionally” or “for example” indicate examples, illustrations or explanations. In the present disclosure, any embodiment or design described as “optionally” or “for example” should not be interpreted as being more preferred or having greater advantages than other embodiments or designs. Specifically, the use of “optionally” or “for example” is intended to present related concepts in a specific manner.

In the embodiments of the present disclosure, “at least one” refers to one or more, and “more” refers to two or more. “And/or” describes the association relationship of associated objects, indicating that three relationships may exist. For example, A and/or B may represent: the existence of A alone, the existence of A and B at the same time, and the existence of B alone, where A and B may be singular or plural. The character “/” generally indicates that the previous and next associated objects are in an “or” relationship. “At least one of the following items” or similar expressions refers to any combination of these items, including any combination of single items or plural items. For example, at least one of a, b or c may represent: a, b, c, a-b, a-c, b-c, or a-b-c, where a, b, c may be single or multiple.

It should be noted that the drawings provided in the following embodiments are merely schematic representations intended to convey the fundamental concept of the present disclosure. Accordingly, the drawings depict only components relevant to the present disclosure and do not reflect the actual number, shape, or dimensions of components in practical implementation. The configuration, quantity, and proportions of the components in actual embodiments may be subject to arbitrary modifications, and the layout of such components may be more complex.

Traditional storage server architectures typically employ redundant control node designs to meet high availability requirements, using dual-path independent hardware for redundant fault tolerance. However, in order to ensure control node interchangeability, traditional solutions mandate a symmetrical routing topology, forcing short distance lines to use the same count of re-timers as long distance lines. For example, a control node only requires a 5000-mil trace (compliant with Peripheral Component Interconnect Express (PCIe) Specifications), but another node requires a re-timer because its traces are significantly longer (14000 mil), which leads to increased hardware redundancy and increased costs.

To address at least the aforementioned issues, the embodiments of the present disclosure provide a wiring method. The wiring method comprises: cross-connecting a storage medium to at least two control nodes so that dual ports of the storage medium are respectively connected to different processor ports of different control nodes; merging long distance lines between the at least two control nodes and the storage medium using re-timers; and dynamically configuring a physical address corresponding to each line of the control node so that a physical address of the storage medium remains consistent when connected to different control nodes.

In the embodiments of the present disclosure, the storage medium is cross-connected to the at least two control nodes so that the dual ports of the storage medium are respectively connected to different processor ports of different control nodes; the long distance lines are merged using the re-timer; and the physical address corresponding to each line of the control node is dynamically configured so that the physical address of the storage medium remains consistent when connected to different control nodes. The wiring method can solve the problem of the count of re-timers under the premise of consistent physical addresses, thereby optimizing the wiring layout, reducing redundant architecture, and improving the operation efficiency of the entire machine.

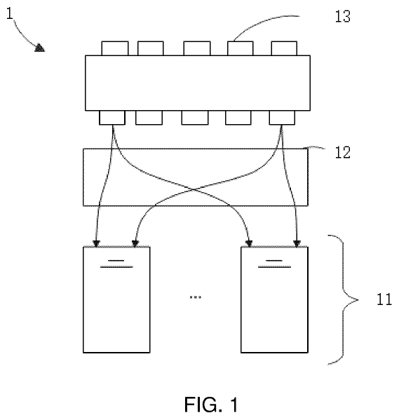

FIG. 1 is a schematic diagram showing an application scenario of a wiring method according to the present disclosure. A printed circuit board 1 may be configured to implement the wiring method provided in the embodiments of the present disclosure, but the application scenarios of the wiring method provided in the embodiments of the present disclosure are not limited to the printed circuit board 1 shown in FIG. 1. As shown in FIG. 1, the printed circuit board 1 comprises nodes 11, a circuit backplane 12, and a Non-Volatile Memory Express (NVMe) drive 13. The wiring method provided in the embodiments of the present disclosure can be applied to the printed circuit board 1.

The printed circuit board 1 in FIG. 1 may serve as a mechanical support and electrical connection foundation, connecting various electronic components (e.g., resistors, capacitors, chips, etc.) through conductive paths. Although FIG. 1 only shows two nodes 11, one circuit backplane 12, and one NVMe drive 13, it should be understood that the example in FIG. 1 is only for understanding this solution, and the specific count of nodes 11 and NVMe drives 13 should be flexibly determined based on actual conditions.

In some embodiments, the printed circuit board 1 may not comprise the circuit backplane 12, but only comprise a node 11 and an NVMe drive 13, each provided with an interface. The wiring method provided in the embodiments of the present disclosure can be applied to the printed circuit board 1. The nodes 11 are a plurality of identical nodes, each of which has an independently running CPU. The NVMe drive 13 is a dual-port interface standard for solid-state drives and other storage devices, configured to utilize the high-speed data transmission capabilities of a PCIe bus to significantly improve storage performance.

The technical solutions in the embodiments of the present disclosure will be described in detail below with reference to the accompanying drawings in the embodiments of the present disclosure.

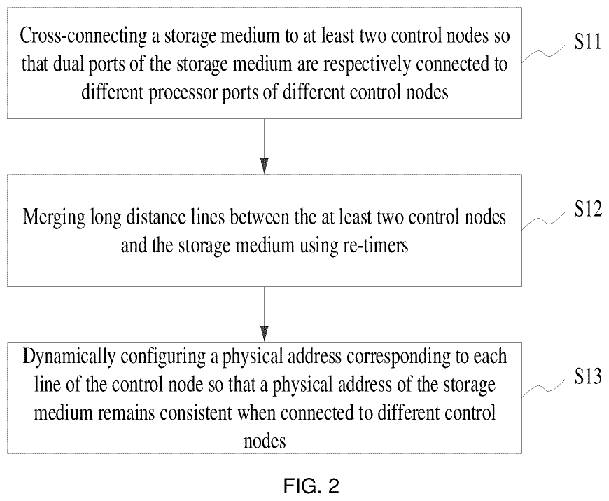

The following embodiments of the present disclosure provide a wiring method, which can be implemented, for example, using the printed circuit board 1 shown in FIG. 1. FIG. 2 is a schematic flowchart showing the wiring method according to the embodiments of the present disclosure. As shown in FIG. 2, the wiring method comprises steps S11-S13.

Step S11 comprises cross-connecting a storage medium to at least two control nodes so that dual ports of the storage medium are respectively connected to different processor ports of different control nodes. The storage medium is an NVMe drive, which is configured to be connected to other devices using the high-speed data transmission capabilities of the PCIe bus. The control nodes are independent nodes, each of which having an independently running processor.

Step S12 comprises merging long distance lines between the at least two control nodes and the storage medium using re-timers. Each of the re-timers is configured to reconstruct a signal using an internal clock as the signal passes by, thereby increasing the signal transmission energy and transmission distance. Specifically, the re-timer requires firmware to operate properly.

Step S13 comprises dynamically configuring a physical address corresponding to each line of the control node so that a physical address of the storage medium remains consistent when connected to different control nodes.

In some embodiments, the two control nodes have a left-right architecture with identical hardware design. To meet the 1+1 redundancy requirement of swapping the two control nodes to ensure either of the two control nodes can seamlessly take over in the event of a failure of the other, each control node is connected to a separate storage medium (NVMe drive). For example, NVMe drive #1 is connected to P0 ports of two control node processors, and NVMe drive #24 is connected to P4 ports of the two control node processors. Based on the above architecture, a line from a head port of the NVMe drives (i.e., NVMe drive #1) to the first control node is A1+A2=4000 mil+1000 mil=5000 mil. A line from the head port of the NVMe drives to the second control node is B1+B2=13000 mil+1000 mil=14000 mil. A line from a tail port of the NVMe drives to the first control node is B1+B2=13000 mil+1000 mil=14000 mil. A line from the tail port of the NVMe drives to the second control node is A1+A2=4000 mil+1000 mil=5000 mil. Accordingly, since the line from the head port of the NVMe drives to the second control node and the line from the tail port of the NVMe drives to the first control node are greater than a longest line threshold of a PCIe line, i.e., 10,000 mil, a re-timer needs to be added to increase the signal intensity. Since the two control nodes need to remain consistent, the other PCIe lines of the two control nodes also need to add the re-timers. Accordingly, for the lines that do not exceed the longest line threshold of the PCIe line, a waste of the re-timer architecture is caused, and the redundant architecture cost is increased. The wiring method in the embodiments of the present disclosure cross-connects the storage medium to the at least two control nodes so that the dual ports of the storage medium are respectively connected to different processor ports of different control nodes. Specifically, the head port of the NVMe drives is connected to the P0 port of the first control node processor and the P4 port of the second control node processor, the tail port of the NVMe drives is connected to the P4 port of the first control node processor and the P0 port of the second control node processor. Based on the above architecture, the line from the head port of the NVMe drives to the first control node is A1+A2=5000 mil. The line from the tail port of the NVMe drives to the first control node is B1+B2=13000 mil+1000 mil=14000 mil. The line from the head port of the NVMe drives to the second control node is B1+B2=17000 mil+1000 mil=18000 mil. The line from the tail port of the NVMe drives to the second control node is A1+A2-9000 mil. Accordingly, since the line from the head port of the NVMe drives to the second control node and the line from the tail port of the NVMe drives to the first control node are greater than the longest line threshold of the PCIe line, i.e., 10000 mil, the long distance line from the first control node to the tail port of the storage medium and the long distance line from the second control node to the head port of the storage medium are merged using the re-timer, to increase the signal intensity and ensure transmission quality. At this time, the architecture of the two control nodes remains consistent, and there is no need to add an additional re-timer. The physical address corresponding to each line of the control node is dynamically configured so that the physical address of the storage medium remains consistent when connected to different control nodes.

In the embodiments of the present disclosure, the storage medium is cross-connected to the at least two control nodes so that the dual ports of the storage medium are respectively connected to different processor ports of different control nodes; the long distance lines are merged using the re-timer; and the physical address corresponding to each line of the control node is dynamically configured so that the physical address of the storage medium remains consistent when connected to different control nodes. The wiring method can solve the problem of the count of re-timers under the premise of consistent physical addresses, thereby optimizing the wiring layout, reducing redundant architecture, and improving the operation efficiency of the entire machine.

In one embodiment of the present disclosure, the at least two control nodes comprise a first control node and a second control node, and the processor ports comprise a first port and a second port. The storage medium is cross-connected to the control nodes so that the dual ports of the storage medium are respectively connected to different processor ports of different control nodes. Specifically, the head port of the storage medium is connected to the first port of the first control node processor, and the tail port of the storage medium is connected to the first port of the second control node processor.

The head port of the storage medium is connected to the second port of the second control node processor, and the tail port of the storage medium is connected to the second port of the first control node processor.

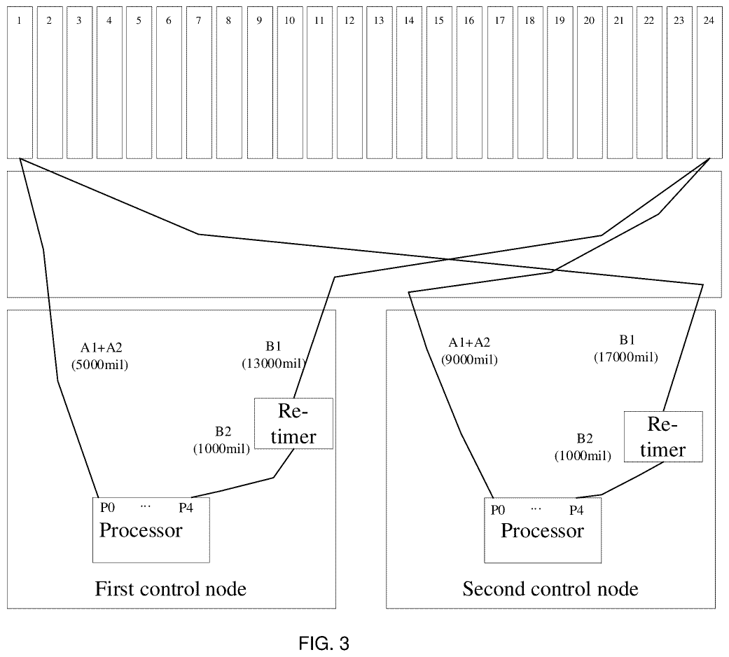

In some possible implementations, as shown in FIG. 3, the control nodes comprise a first control node and a second control node, and each processor comprises a first port P0 and a second port P4. The implementation of cross-connecting the storage medium to the control nodes so that the dual ports of the storage medium are respectively connected to different processor ports of different control nodes comprises: a head port 1 of a storage medium is connected to the first port P0 of the first control node processor, and a tail port 24 of the storage medium is connected to the first port P0 of the second control node processor. The head port 1 of the storage medium is connected to the second port P4 of the second control node processor, and the tail port 24 of the storage medium is connected to the second port P4 of the first control node processor. The re-timers are configured on a line between the head port 1 of the storage medium and the second port P4 of the second control node processor and a line between the tail port 24 of the storage medium and the second port P4 of the first control node processor, respectively.

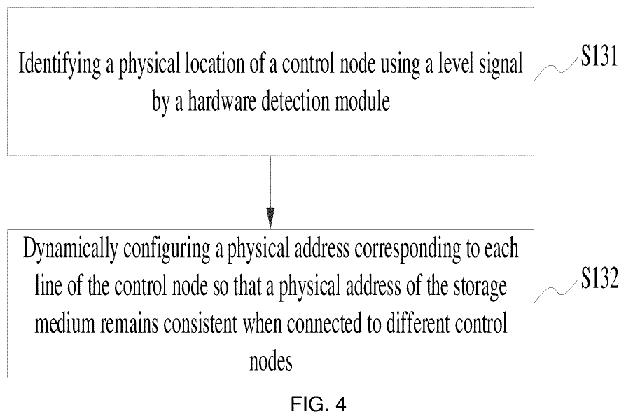

FIG. 4 is a schematic flowchart showing a wiring method according to the embodiments of the present disclosure. As shown in FIG. 4, step S13 comprises steps S131-S132.

Step S131 comprises identifying a physical location of a control node using a level signal by a hardware detection module.

Step S132 comprises dynamically configuring the physical address corresponding to each line according to the physical location of the control node so that the physical address of the storage medium remains consistent when connected to different control nodes.

In some embodiments, the head port of the storage medium is connected to the P0 port of the first control node processor and the P4 port of the second control node processor. Inconsistency in the physical addresses (i.e., physical locations) of the two control nodes causes a disorder in system maintenance. Synchronous update of the physical addresses is achieved using the hardware detection module and software optimization. The hardware detection module determines which control node the signal originates from based on the level signal, for example, the first control node sends a low-level signal and the second control node sends a high-level signal. The physical address corresponding to each line is dynamically configured based on the physical location of the control node, so that the physical address of the storage medium remains consistent when connected to different control nodes.

In one embodiment of the present disclosure, identifying a physical location of each of the control nodes using a level signal by a hardware detection module comprises: generating a high-level signal by connecting one of the control nodes to a power supply using a first resistor, and generating a low-level signal by connecting the other one of the control nodes to the ground using a second resistor; assigning the high-level signal and the low-level signal to different control nodes, respectively, to identify the physical locations of the control nodes.

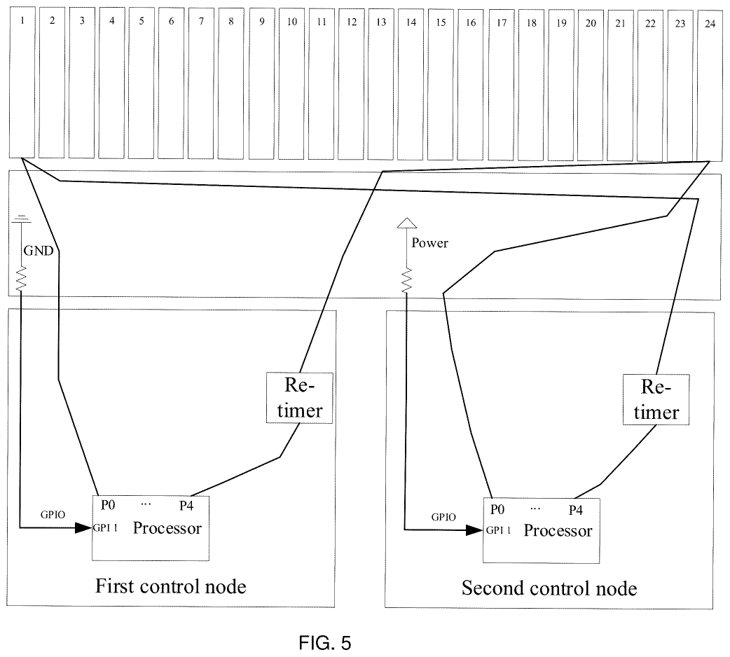

In some embodiments, as shown in FIG. 5, the control nodes comprise a first control node and a second control node, and each control node processor comprises a first port P0 and a second port P4. The head port 1 of the storage medium is connected to the first port P0 of the first control node processor, and the tail port 24 of the storage medium is connected to the first port P0 of the second control node processor. The head port 1 of the storage medium is connected to the second port P4 of the second control node processor, and the tail port 24 of the storage medium is connected to the second port P4 of the first control node processor. The re-timers are configured on a line between the head port 1 of the storage medium and the second port P4 of the second control node processor and a line between the tail port 24 of the storage medium and the second port P4 of the first control node processor, respectively. A port GPI1 of the first control node is connected to a second resistor, and a port GPI1 of the second control node is connected to a first resistor. The first resistor is connected to a power supply to generate a high-level signal, and the second resistor is connected to the ground to generate a low-level signal. The high-level signal is assigned to the second control node, and the low-level signal is assigned to the first control node. Upon insertion into the first control node, the second resistor is grounded and connected to the GPI1 of the first control node processor. The GPI1 determines the low-level signal and identifies the node as the first control node. Upon insertion into the second control node, one end of the first resistor is connected to the power supply and the other end of the first resistor is connected to the GPI1 of the second control node processor. The GPI1 determines the high-level signal and identifies the node as the second control node.

In one embodiment of the present disclosure, the control nodes comprise a first control node and a second control node, and the identifying a physical location of each of the control nodes using a level signal by a hardware detection module comprises: when the hardware detection module identifies the first control node using the level signal, the first port of the first control node processor is configured to be connected to the head port of the storage medium, and the second port of the first control node processor is configured to be connected to the tail port of the storage medium.

When the hardware detection module identifies the second control node using the level signal, the first port of the second control node processor is configured to be connected to the tail port of the storage medium, and the second port of the second control node processor is configured to be connected to the head port of the storage medium.

In some embodiments, the control nodes comprise a first control node and a second control node, and identifying a physical location of each of the control nodes using a level signal by a hardware detection module comprises: when the hardware detection module identifies the first control node using the level signal, the first port of the first control node processor is configured to be connected to the head port of the storage medium, and the second port of the first control node processor is configured to be connected to the tail port of the storage medium. When the hardware detection module identifies the second control node using the level signal, the first port of the second control node processor is configured to be connected to the tail port of the storage medium, and the second port of the second control node processor is configured to be connected to the head port of the storage medium. Table 1 shows the physical addresses of the control nodes described in the embodiments of the present disclosure. As shown in Table 1, the bus-device-function (BDF) address corresponding to the P0 port of the first control node processor is 010; when the GPI1 port is 0, the corresponding line is determined to be connected to a head port slot 1 of the storage medium. The BDF address corresponding to the P4 port of the first control node processor is 100; when the GPI1 port is 0, the corresponding line is determined to be connected to a tail port slot 24 of the storage medium. The BDF address corresponding to the P0 port of the second control node processor is 010; when the GPI1 port is 1, the corresponding line is determined to be connected to a tail port slot 24 of the storage medium. The BDF address corresponding to the P4 port of the second control node processor is 100; when the GPI1 port is 1, the corresponding line is determined to be connected to the head port slot 1 of the storage medium.

TABLE 1
Physical addresses of control nodes

| Processor | | | | | Storage |
|---|---|---|---|---|---|
| port | Bus | Device | Function | GPI1 | medium port |
| Control node | 0 | 1 | 0 | 0 | Slot1 |
| 1-P0 | | | | | |
| Control node | 1 | 0 | 0 | | Slot24 |
| 1-P4 | | | | | |
| Control Node | 0 | 1 | 0 | 1 | Slot24 |
| 2-P0 | | | | | |
| Control Node | 1 | 0 | 0 | | Slot1 |
| 2-P4 | | | | | |

In one embodiment of the present disclosure, the re-timers are configured for long distance lines exceeding a preset threshold, specifically, 10000 mil. If the length of the distance line exceeds the preset threshold 10000 mil, a re-timer is required to enhance the signal intensity.

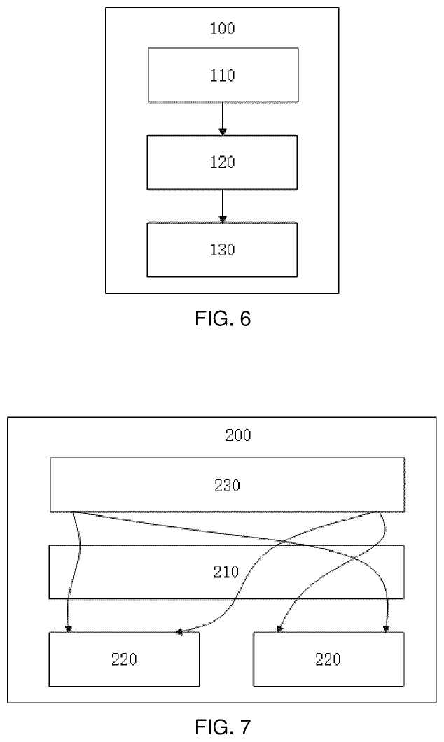

FIG. 6 is a schematic structural diagram showing a wiring system according to the embodiments of the present disclosure. As shown in FIG. 6, a wiring system 100 comprises a line layout module 110, a line merging module 120, and an address mapping module 130.

The line layout module 110 is configured to cross-connect a storage medium to at least two control nodes so that dual ports of the storage medium are respectively connected to different processor ports of different control nodes.

The line merging module 120 is configured to merge long distance lines between the at least two control nodes and the storage medium using re-timers.

The address mapping module 130 is configured to dynamically configure a physical address corresponding to each line of the control node so that a physical address of the storage medium remains consistent when connected to different control nodes.

In some embodiments, the line layout module 110 is configured to connect the head port of the NVMe drive to the P0 port of the first control node processor and the P4 port of the second control node processor, and connect the tail port of the NVMe drive to the P4 port of the first control node processor and the P0 port of the second control node processor. Based on the above architecture, a line from the head port of the NVMe drive to the first control node is A1+A2=5000 mil. A line from the tail port of the NVMe drive to the first control node is B1+B2=13000 mil+1000 mil=14000 mil. A line from the head port of the NVMe drive to the second control node is B1+B2=17000 mil+1000 mil=18000 mil. A line from the tail port of the NVMe drive to the second control node is A1+A2-9000 mil. Accordingly, since the line from the head port of the NVMe drive to the second control node and the line from the tail port of the NVMe drive to the first control node are greater than the longest line threshold of the PCIe line, i.e., 10,000 mil, the line merging module 120 is used to merge the long distance line from the first control node to the tail port of the storage medium and the long distance line from the second control node to the head port of the storage medium using the re-timers, to enhance the signal intensity and ensure transmission quality. At this time, the architecture of the two control nodes remains consistent and no additional re-timer is needed. The address mapping module 130 is configured to dynamically configure the physical address corresponding to each line of the control node so that the physical address of the storage medium remains consistent when connected to different control nodes.

In the embodiments of the present disclosure, the line layout module 110 is configured to cross-connect the storage medium to the control nodes, so that the two ports of the storage medium are connected to different processor ports of different control nodes. The line merging module 120 is configured to merge the long distance lines using the re-timer, and the address mapping module 130 is configured to dynamically configure the physical address corresponding to each line of the control node so that the physical address of the storage medium remains consistent when connected to different control nodes. The wiring system 100 can solve the problem of the count of re-timers while maintaining consistency in physical addresses, thereby optimizing the wiring layout, reducing the redundant architecture, and improving the operation efficiency of the overall machine.

FIG. 7 is a schematic structural diagram showing a chip according to the embodiments of the present disclosure. As shown in FIG. 7, a chip 200 comprises a backplane 210, at least two control nodes 220, and a plurality of dual-port storage medium 230.

The backplane 210 is configured to provide physical connection interfaces.

The at least two control nodes 220 are configured to execute the wiring method as described in any embodiment of the present disclosure.

The plurality of dual-port storage media 230 are configured to be cross-connected to the control nodes 220 through the backplane 210, two ports of each storage medium 230 being connected to different control nodes 220, respectively.

In the embodiments provided in the present disclosure, it should be understood that the disclosed systems, devices or methods can be implemented in other ways. For example, the device embodiments described above are only schematic. For example, the division of modules/units is only a logical function division. There may be other division modes in actual implementation. For example, multiple modules or units can be combined or integrated into another system, or some features can be ignored or not executed. Another point is that the coupling, direct coupling, or communication connection shown or discussed between components may refer to indirect coupling or communication through one or more interfaces, devices, modules, or units, and may be electrical, mechanical, or in other forms.

The modules/units described as separate components may or may not be physically separate, and the components displayed as modules/units may or may not be physical modules, that is, they may be located in one place or distributed across multiple network elements. Some or all of the modules/units may be selected according to actual needs to achieve the purpose of the embodiments of the present disclosure. For example, the functional modules/units in the various embodiments of the present disclosure may be integrated into a processing module, or each module/unit may exist physically separately, or two or more modules/units may be integrated into a single module/unit.

Those skilled in the art should further appreciate that the units and algorithm steps of each example described in conjunction with the embodiments disclosed herein can be implemented in electronic hardware, computer software, or a combination thereof. In order to clearly illustrate the interchangeability of hardware and software, the above description has generally described the composition and steps of each example according to function. Whether these functions are performed in hardware or software depends on the specific application and design constraints of the technical solution. Professional and technical personnel can use different methods to implement the described functions for each specific application, but such implementation should not be considered to be beyond the scope of the present disclosure.

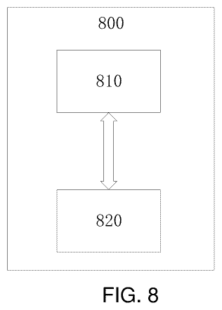

The present disclosure further provides an electronic device. FIG. 8 is a schematic structural diagram showing an electronic device 800 according to the embodiments of the present disclosure. As shown in FIG. 8, the electronic device 800 comprises a memory 810 and a programmable logic device 820.

The memory 810 is configured to store programmable logic programs. The programmable logic device 820 is configured to load the programmable logic programs stored in the memory 810 so that the electronic device 800 executes the wiring method described in any embodiment of the present disclosure.

The present disclosure further provides a non-volatile readable storage medium, comprising programmable logic programs. When the programs are executed by a processor, the wiring method described in any embodiment of the present disclosure is implemented.

As used in this specification, the terms “component,” “module,” “system,” or the like are used to refer to computer-related entities, hardware, firmware, a combination of hardware and software, software, or software in execution. For example, a component may be, but is not limited to, a process running on a processor, a processor, an object, an executable file, an execution thread, a program, and/or a computer. By way of illustration, both an application running on a computing device and the computing device may be a component. One or more components may reside in a process and/or an execution thread, and a component may be located on a single computer and/or distributed across two or more computers. In addition, these components may be executed from various computer-readable media having various data structures stored thereon. Components may communicate, for example, via local and/or remote processes based on signals having one or more data packets (e.g., data from two components interacting with another component on a local system, a distributed system, and/or a network, such as the Internet interacting with other systems via signals).

The descriptions of the processes or structures corresponding to the above figures have different emphases. For parts that are not described in detail in a certain process or structure, please refer to the relevant descriptions of other processes or structures.

The above embodiments are merely illustrative of the principles and effects of the present disclosure and are not intended to limit the present disclosure. Anyone skilled in the art may modify or alter the above embodiments without departing from the spirit and scope of the present disclosure. Therefore, all equivalent modifications or alterations made by those having ordinary skills in the art without departing from the spirit and technical concepts disclosed in the present disclosure shall be covered by the present disclosure.

1.-10. (canceled)

11. A wiring method, comprising:
cross-connecting a storage medium to at least two control nodes so that dual ports of the storage medium are respectively connected to different processor ports of different control nodes;
merging long distance lines between the at least two control nodes and the storage medium using re-timers; and
dynamically configuring a physical address corresponding to each line of the control node so that a physical address of the storage medium remains consistent when connected to different control nodes.

12. The wiring method of claim 11, wherein the at least two control nodes comprise a first control node and a second control node, and
wherein control node processors comprise a first control node processor and a second control node processor.

13. The wiring method of claim 12, wherein the processor ports for each of the control node processors comprise a first port and a second port.

14. The wiring method of claim 13, wherein the storage medium is cross-connected to the control nodes so that the dual ports of the storage medium are respectively connected to different processor ports of different control nodes.

15. The wiring method of claim 14, wherein:
a head port of the storage medium is connected to the first port of the first control node processor, and a tail port of the storage medium is connected to the first port of the second control node processor, and
the head port of the storage medium is connected to the second port of the second control node processor, and the tail port of the storage medium is connected to the second port of the first control node processor.

16. The wiring method of claim 11, wherein dynamically configuring the physical address corresponding to each line of the control node comprises:
identifying a physical location of each of the control nodes using a level signal by a hardware detection module; and
dynamically configuring the physical address corresponding to each line of the physical location of the control node so that the physical address of the storage medium remains consistent when connected to different control nodes.

17. The wiring method of claim 16, wherein identifying the physical location of each of the control nodes using a level signal by a hardware detection module comprises:
generating a high-level signal by connecting one of the control nodes to a power supply using a first resistor; and
generating a low-level signal by connecting an other one of the control nodes to ground using a second resistor.

18. The wiring method of claim 17, wherein identifying the physical location of each of the control nodes further comprises:
assigning the high-level signal and the low-level signal to different control nodes, respectively, to identify the physical locations of the control nodes.

19. The wiring method of claim 16, wherein the at least two control nodes comprise a first control node and a second control node.

20. The wiring method of claim 19, wherein control node processors comprise a first control node processor and a second control node processor, and wherein the processor ports for each of the control node processors comprise a first port and a second port.

21. The wiring method of claim 20, wherein the identifying a physical location of each of the control nodes using a level signal by a hardware detection module comprises:
when the hardware detection module identifies the first control node using the level signal, the first port of the first control node processor is configured to be connected to a head port of the storage medium, and the second port of the first control node processor is configured to be connected to a tail port of the storage medium.

22. The wiring method of claim 20, wherein the identifying a physical location of each of the control nodes using a level signal by a hardware detection module comprises:
when the hardware detection module identifies the second control node using the level signal, the first port of the second control node processor is configured to be connected to a tail port of the storage medium, and the second port of the second control node processor is configured to be connected to a head port of the storage medium.

23. The wiring method of claim 11, wherein each of the long distance lines exceeds a preset threshold and is configured with one re-timer.

24. A wiring system, comprising:
a line layout module, configured to cross-connect a storage medium to at least two control nodes so that dual ports of the storage medium are respectively connected to different processor ports of different control nodes;
a line merging module, configured to merge long distance lines between the at least two control nodes and the storage medium using re-timers; and
an address mapping module, configured to dynamically configure a physical address corresponding to each line of the control node so that a physical address of the storage medium remains consistent when connected to different control nodes.

25. An electronic device, comprising:
a memory, configured to store programmable logic programs;
a programmable logic device, configured to load the programmable logic programs stored in the memory so that the electronic device executes a wiring method comprising:
cross-connecting a storage medium to at least two control nodes so that dual ports of the storage medium are respectively connected to different processor ports of different control nodes;
merging long distance lines between the at least two control nodes and the storage medium using re-timers; and
dynamically configuring a physical address corresponding to each line of the control node so that a physical address of the storage medium remains consistent when connected to different control nodes.

26. The electronic device of claim 25, wherein the at least two control nodes comprise a first control node and a second control node, and
wherein control node processors comprise a first control node processor and a second control node processor.

27. The electronic device of claim 26, wherein the processor ports for each of the control node processors comprise a first port and a second port.

28. The electronic device of claim 27, wherein the storage medium is cross-connected to the control nodes so that the dual ports of the storage medium are respectively connected to different processor ports of different control nodes.

29. The electronic device of claim 28, wherein:
a head port of the storage medium is connected to the first port of the first control node processor, and a tail port of the storage medium is connected to the first port of the second control node processor, and
the head port of the storage medium is connected to the second port of the second control node processor, and the tail port of the storage medium is connected to the second port of the first control node processor.

30. The electronic device of claim 25, wherein dynamically configuring the physical address corresponding to each line of the control node comprises:
identifying a physical location of each of the control nodes using a level signal by a hardware detection module; and
dynamically configuring the physical address corresponding to each line of the physical location of the control node so that the physical address of the storage medium remains consistent when connected to different control nodes.
